(19) United States
(12) Patent Application Publication
(10) Pub. No.: US 2002/0148852 A1
(43) Pub. Date: Oct. 17, 2002

(54) Liquid dispensing and administering system

(76) Inventor: Joseph P. Schultz, Phoenix, AZ (US)

Correspondence Address: STONEMAN LAW OFFICES, LTD, 3113 NORTH 3RD STREET, PHOENIX, AZ, 85012, US

(21) Appl. No.: 10/124,985

(22) Filed: Apr. 17, 2002

Related U.S. Application Data
(60) Provisional application No. 60/284,401, filed on Apr. 17, 2001.

(51) Int. Cl. B67D 1/00

(52) U.S. Cl. 222/78; 222/212

(57) ABSTRACT

A system for administering measured liquids, such as medicine, vitamins and feedings of foods to persons including adults, infants and small children. The system comprises a dispensing spoon, connected by a luer fitting, to at least one medical-type syringe. The syringe allows the liquid to be delivered to the spoon in accurately measured amounts. An embodiment of the invention provides a spoon having an integral liquid holding funnel, allowing a dispensed liquid to be held before being drawn into the syringe. The system may be reusable or disposable, and is preferably constructed of medical grade plastic.

### CROSS-REFERENCE TO RELATED APPLICATION

The present application is related to applicant's prior U.S. Provisional Application No. 60/284,401, filed Apr. 17, 2001, entitled “LIQUID DISPENSING AND ADMINISTERING SYSTEM”, the contents of which are herein incorporated by reference and are not admitted to be prior art with respect to the present invention by their mention in this cross-reference section.

### BACKGROUND

This invention relates to providing a system for administering measured liquids, such as medicine, vitamins and feedings of foods to individuals, including infants, small children and adults. Often, infants, small children and some adults present a challenge when an attempt is made to administer a measured liquid. Historically, measured liquids of various types have been poured from a liquid holder into a spoon prior to administration to a recipient. This method has a number of inherent drawbacks, as the spoon must be carefully placed against the lip of a bottle, and then, without spilling, must be poured carefully into the spoon. This method typically lacks accuracy due to the variability between one person's pouring technique and that of another, and between one type of spoon and another. The spoon, after receiving the measured liquid, must be carefully conveyed to the recipient's mouth without spilling the measured liquid. In situations where the recipient is reluctant to receive the measured liquid, as often encountered with small children, the likelihood of delivering the full volume of liquid is poor. Another method of administering measured liquids has consisted of using a syringe to withdraw a carefully measured amount of liquid from a bottle. While this is an accurate method of decanting the liquid from a bottle, the procedure has several drawbacks; each introduction of a syringe tip into the bottle creates an opportunity for contamination of the contained liquid, and as previously described, small children not familiar with consuming liquids directly from a syringe, typically object strenuously to this procedure. Administering a measured liquid to a small child is particularly difficult when the administering person is unfamiliar to the child, e.g., medical personnel.

A need exists for a safe, accurate and easy to use system for dispensing and administering measured liquids. More specifically, a need exists for an inexpensive liquid dispensing and administering system that provides a decreased risk of spillage, a low risk of cross-contamination, and that is suitable for administering the measured liquids to adults, small children and infants.

### OBJECTS AND FEATURES OF THE INVENTION

A primary object and feature of the present invention is to fulfill the above-mentioned needs by providing a liquid dispensing and administering system for accurately dispensing liquids into a suitable receptacle. It is another object and feature of the present invention to provide a liquid dispensing and administering system that provides at least one adaptation to assist in filling at least one liquid source. It is another object and feature of the present invention to provide a liquid dispensing and administering system for administering the dispensed liquids to adults, small children and infants. It is a further object and feature of this invention to provide such a system that is efficient, economical and handy.

The foregoing and other objects, features and advantages of the present invention will be apparent from the following, more particular, description of the embodiments of the invention, as illustrated in the accompanying drawings.

### SUMMARY OF THE INVENTION

In accordance with a preferred embodiment of the present invention, this invention provides a liquid dispensing and administering system for the controlled dispensing of at least one liquid from at least one liquid source to a mouth of at least one user comprising, in combination: dispenser-spoon means for delivering at least one liquid into the mouth; coupling means for coupling such dispenser-spoon means to the at least one liquid source; and channel means for transfer of the at least one liquid from such coupling means to such dispenser-spoon means.

Additionally, it provides such a system wherein such channel means is sized to receive a measured amount of the at least one liquid from the at least one liquid source while placed in a substantially vertical orientation. Further it provides such a system wherein such dispenser-spoon means is sized to receive a measured amount of the at least one liquid from the at least one liquid source while placed in a substantially horizontal orientation. Moreover, it provides such a system wherein such channel means is sized to receive a measured amount of the at least one liquid from the at least one liquid source while placed in a substantially horizontal orientation. Additionally, it provides such a system wherein such channel means is structured and arranged to retain such minimal amount of a measured amount of the at least one liquid being transferred that substantially all of the measured amount may be dispensed.

In accordance with another preferred embodiment hereof, this invention provides a liquid dispensing and administering system for the controlled dispensing of at least one liquid from at least one liquid source to a mouth of at least one user comprising, in combination: at least one dispenser-spoon structured and arranged to hold the at least one liquid to be dispensed; at least one coupling structured and arranged to removably couple such at least one dispenser-spoon to the at least one liquid source; and at least one channel structured and arranged to transfer the at least one liquid from such at least one coupling to such at least one dispenser-spoon. Additionally, it provides such a system wherein such at least one coupling comprises at least one luer slip coupling. Further, it provides such a system wherein such at least one coupling comprises at least one luer lock coupling. Moreover, it provides such a system wherein said at least one coupling is structured and arranged to receive at least one oral syringe safety tip. And, it provides such a system wherein such channel is structured and arranged to retain such minimal amount of a measured amount of the at least one liquid being transferred that substantially all of the measured amount may be dispensed. Additionally, it provides such a system wherein such at least one dispenser-spoon is sized to receive at least one measured amount of the at least one liquid while placed in a substantially horizontal orientation. Furthermore, it provides such a system wherein such at least one channel is sized to contain at least one measured amount of the at least one liquid while placed in a substantially horizontal orientation.

Further, it provides such a system wherein such at least one channel is sized to contain at least one measured amount of the at least one liquid while placed in a substantially vertical orientation. It further provides such a system wherein such at least one channel comprises: at least one hollow cone having at least one first wider open end and at least one second narrower open end; wherein at least one portion of such at least one first wider open end is integral with such at least one dispenser-spoon; and wherein such at least one narrower second open end is integral with such at least one coupling.

In accordance with another preferred embodiment hereof, this invention provides a liquid dispensing and administering system for the controlled dispensing of at least one liquid from at least one liquid source to a mouth of at least one user comprising, in combination: at least one syringe; at least one dispenser-spoon structured and arranged to hold the at least one liquid to be dispensed; at least one intermediate coupling structured and arranged to removably couple such at least one dispenser-spoon to such at least one syringe; and at least one channel structured and arranged to transfer the at least one liquid from such at least one intermediate coupling to such at least one dispenser-spoon; and wherein such at least one syringe comprises at least one luer coupling. Additionally, it provides such a system wherein such at least one luer coupling comprises at least one luer slip coupling. Further, it provides such a system wherein such channel is structured and arranged to retain such minimal amount of a measured amount of the at least one liquid being transferred that substantially all of the measured amount may be dispensed.

Moreover, it provides such a system wherein such at least one channel is sized to receive at least one measured amount of the at least one liquid while placed in a substantially horizontal orientation. Additionally, it provides such a system wherein such at least one channel is sized to receive at least one measured amount of the at least one liquid while placed in a substantially vertical orientation. Furthermore, it provides such a system wherein such at least one channel comprises: at least one hollow cone having at least one first wider open end and at least one narrower second open end; wherein at least one portion of such at least one first wider open end is integral with such at least one dispenser-spoon; and wherein such at least one second narrower open end is integral with such at least one luer slip coupling. Additionally, it provides such a system wherein such at least one luer coupling comprises at least one luer lock coupling.

In addition, it provides such a system wherein such channel is structured and arranged to retain such minimal amount of a measured amount of the at least one liquid being transferred that substantially all of the measured amount may be dispensed. Furthermore, it provides such a system wherein such at least one channel is sized to receive at least one measured amount of the at least one liquid while placed in a substantially horizontal orientation. Further, it provides such a system wherein such at least one channel is sized to receive at least one measured amount of the at least one liquid while placed in a substantially vertical orientation. Even further, it provides such a system wherein such at least one channel comprises: at least one hollow cone having at least one first wider open end and at least one narrower second open end; wherein at least one portion of such at least one first wider open end is integral with such at least one dispenser-spoon; and wherein such at least one narrower second open end is integral with such at least one luer lock coupling.

### BRIEF DESCRIPTION OF THE DRAWINGS

FIG. 1 shows an elevational view of the liquid dispensing and administering system, shown in use, dispensing a liquid to a small child or infant according to a preferred embodiment of the present invention.

FIG. 2 shows a perspective view of the liquid dispensing and administering system of FIG. 1 according to a preferred embodiment of the present invention.

FIG. 3 shows a top view of the liquid dispensing and administering system of FIGS. 1 and 2 according to a preferred embodiment of the present invention.

FIG. 4 shows a sectional view through the section 4-4 of FIG. 3 of the liquid dispensing and administering system according to a preferred embodiment of the present invention.

FIG. 5 shows a sectional view through the section 5-5 of FIG. 3 of the liquid dispensing and administering system of FIGS. 1, 2 and 3 according to a preferred embodiment of the present invention.

FIG. 6 shows a perspective view of the liquid dispensing and administering system according to another preferred embodiment of the present invention.

FIG. 7 shows an enlarged partial top view of the liquid dispensing and administering system of FIG. 6 according to a preferred embodiment of the present invention.

FIG. 8 shows a sectional view through section 8-8 of FIG. 6 of the liquid dispensing and administering system according to a preferred embodiment of the present invention.

FIG. 9 shows a perspective view of a lock coupling used in preferred embodiments of the present invention.

FIG. 10 shows a perspective view of the liquid dispensing and administering system according to a further preferred embodiment of the present invention.

FIG. 11 shows a perspective view of the liquid dispensing and administering system according to yet another preferred embodiment of the present invention.

FIG. 12 shows a perspective view showing a liquid dispensing and administering system comprising a dispensing-spoon having a funnel-shaped feature according to another preferred embodiment of the present invention.

FIG. 13 shows a front elevational view of a liquid dispensing and administering system comprising a dispensing-spoon having a funnel-shaped feature according to another preferred embodiment of the present invention.

FIG. 14 shows a top plan view of a liquid dispensing and administering system comprising a dispensing-spoon having a funnel-shaped feature according to another preferred embodiment of the present invention.

FIG. 15 shows a side elevational view of a liquid dispensing and administering system comprising a dispensing-spoon having a funnel-shaped feature according to another preferred embodiment of the present invention.

### DETAILED DESCRIPTION OF A PREFERRED EMBODIMENT OF THE INVENTION

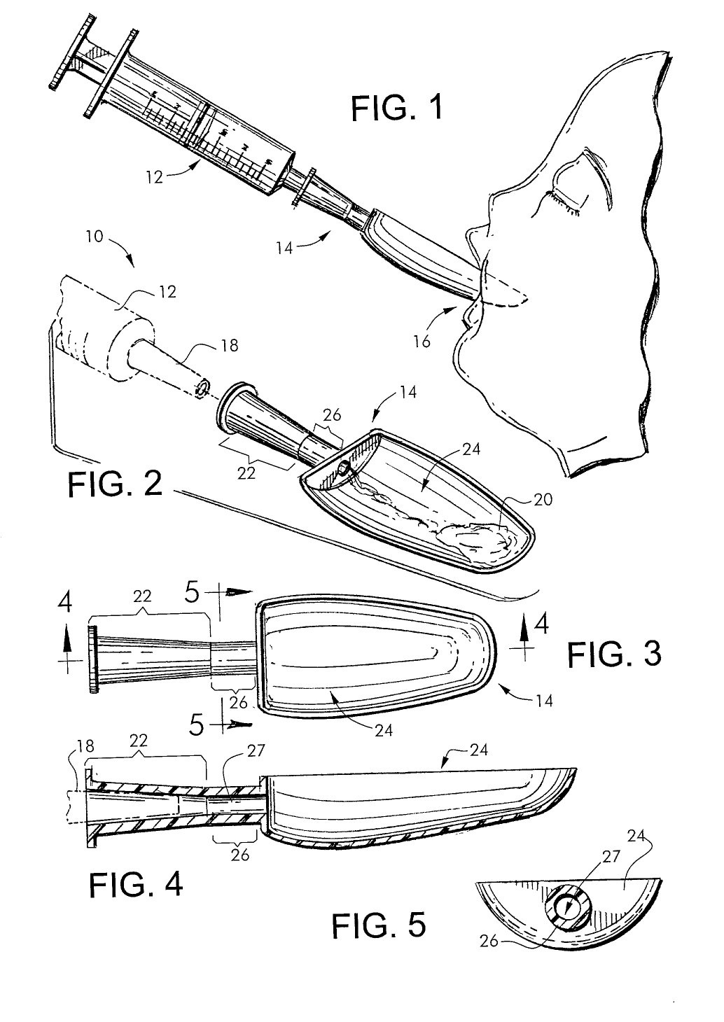

Referring to FIG. 1, an elevational view of the liquid dispensing and administering system , shown in use, dispensing a liquid to a small child or infant, according to a preferred embodiment of the present invention, is shown. Although a small child or infant is depicted, those skilled in the art will recognize that adults will also benefit from the system of the present invention. The liquid dispensing and administering system 10 comprises at least one dispensing spoon 14 (herein embodying dispenser-spoon means), used with and preferably removably attachable to, at least one syringe 12, or similar liquid source, as shown. The syringe 12 may comprise syringes of varying volume, measurement scales and styles, etc. Preferably, syringe 12 is a standard type for general medical use, as shown. Preferably, the dispensing spoon 14 is sized to substantially fit into the recipient's mouth 16, as shown. As the recipient may be an adult, an infant or a small child, under appropriate circumstances, different sized spoons may be preferable to accommodate the size and comfort of the recipient. It shall also be recognized that the preferred sizing of the dispensing spoon 14 may vary between the different embodiments of the present invention as appropriate for different aged or sized adults, children and infants.

It is presently preferred that dispensing spoon 14 be primarily comprised of at least one mold-formed material, preferably plastic, preferably a semi-rigid medical grade PVC. Other medical grade plastics (i.e., EVA, PP, PE, PUR), as well as metals, under appropriate circumstances, may be suitable to produce the system 10. Under appropriate circumstances, at least one portion of the material used to form the dispensing spoon 14 may be transparent or translucent to allow the user to view the contents of the dispensing spoon 14. Any preferred color may be provided to the dispensing spoon 14 by coating, mixing or blending the material forming the dispensing spoon 14 with a pigment and/or dye, or by other well-known methods. Although it is preferred that a single plastic resin be used in the fabrication of the dispensing spoon 14, under appropriate circumstances, two or more materials, copolymers or mixtures may be used.

Under appropriate circumstances, embodiments of the present invention may be utilized for measuring, tasting, cooking, feeding, etc. For example, preferred embodiments of the present invention may be used for feeding measured amounts of nutritive liquids to the elderly, while minimizing spilling, due to the controlled delivery of preferred embodiments of the present invention.

Referring to FIG. 2, a perspective view of the system 10 of FIG. 1 according to a preferred embodiment of the present invention is shown. The syringe 12 preferably comprises at least one male slip coupling 18, as shown. The dispensing spoon 14 preferably comprises at least one female slip coupling 22, as shown. Female slip coupling 22, as shown, is structured and arranged to fit, preferably an oral syringe safety tip and alternately a luer-type coupling (herein embodying coupling means). As shown, female slip coupling 22 is structured and arranged to accept the male slip coupling 18 to form a friction fit. This feature enables the dispensing spoon 14 to be used with more than one syringe 12, and allows the spoon 14 to accommodate syringes 12 of varying size. Additionally, the preferred use of standard couplings reduces the manufacturing cost of the dispensing spoon 14, as most standard mass manufactured medical type syringe(s) 12 may be used in conjunction with the dispensing spoon 14, as shown. As other connectors and couplings come in favor, those skilled in the art may be able to include such connectors and couplings in place of those shown herein. The preferred coupling feature also allows a single syringe 12 to be used with multiple dispensing spoon(s) 14, thereby preventing the spread of disease and greatly reducing the potential for cross-contamination in situations where two or more recipients are administered liquid from the same syringe 12. The dispensing spoon 14 preferably comprises at least one short transfer channel 26 (herein embodying channel means) and at least one bowl section 24, as shown. Preferably, liquid 20 from the syringe 12 is transferred, in a controlled manner, from the syringe 12 through the male and female slip couplings 18 and 22, and then through the short transfer channel 26 and into the bowl section 24 (herein embodying a liquid dispensing and administering system wherein such dispenser-spoon means is sized to receive a measured amount of the at least one liquid from the at least one liquid source while placed in a substantially horizontal orientation). In some preferred embodiments, the short transfer channel 26 is essentially part of the female slip coupling 22, and may preferably be essentially nonexistent, i.e., the slip coupling 22 connected closely adjacent to the bowl section 24. The preferred use of a small volume short transfer channel 26, or the essentially direct connection of the slip coupling 22 to the bowl section 24, reduces the volume of residual liquid caught in the bore of the short transfer channel 26. The interior volume of the short transfer channel 26 is preferably sized to retain such minimal amount of the measured liquid being transferred that substantially the entire measured amount of liquid is dispensed (herein embodying a liquid dispensing and administering system wherein such channel means is structured and arranged to retain such minimal amount of a measured amount of the at least one liquid being transferred that substantially all of the measured amount may be dispensed). The preferred configurations of the short transfer channel 26 effectively prevent inaccuracies when metering the liquid from the syringe 12 into the dispensing spoon 14, and minimize complications arising from residual liquids remaining in the system when the dispensing spoon 14 is reused.

Referring to FIG. 3, a top view of the system 10 of FIGS. 1 and 2, according to a preferred embodiment of the present invention, is shown. Preferably, the dispensing spoon 14 is substantially spoon-shaped, defining at least one essentially concave cavity portion, as shown. Further, the dispensing spoon 14 is preferably bi-symmetrical (symmetrical side-to-side) about the longitudinal axis, as shown; however, under appropriate circumstances, asymmetrical configurations may be preferred.

FIG. 4 is a sectional view through the section 4-4 of FIG. 3 of the liquid dispensing and administering system 10, according to a preferred embodiment of the present invention. As depicted, the male slip coupling 18 preferably forms a friction fit when inserted into the female slip coupling 22, as shown. Also, visible in FIG. 4 is the interior bore 27 of the short transfer channel 26, which provides at least one liquid flow path to the bowl section 24, as shown.

FIG. 5 is a sectional view through the section 5-5 of FIG. 3 of the liquid dispensing and administering system 10 of FIGS. 1, 2 and 3, according to a preferred embodiment of the present invention. The interior bore 27 within the short transfer channel 26 is also shown herein.

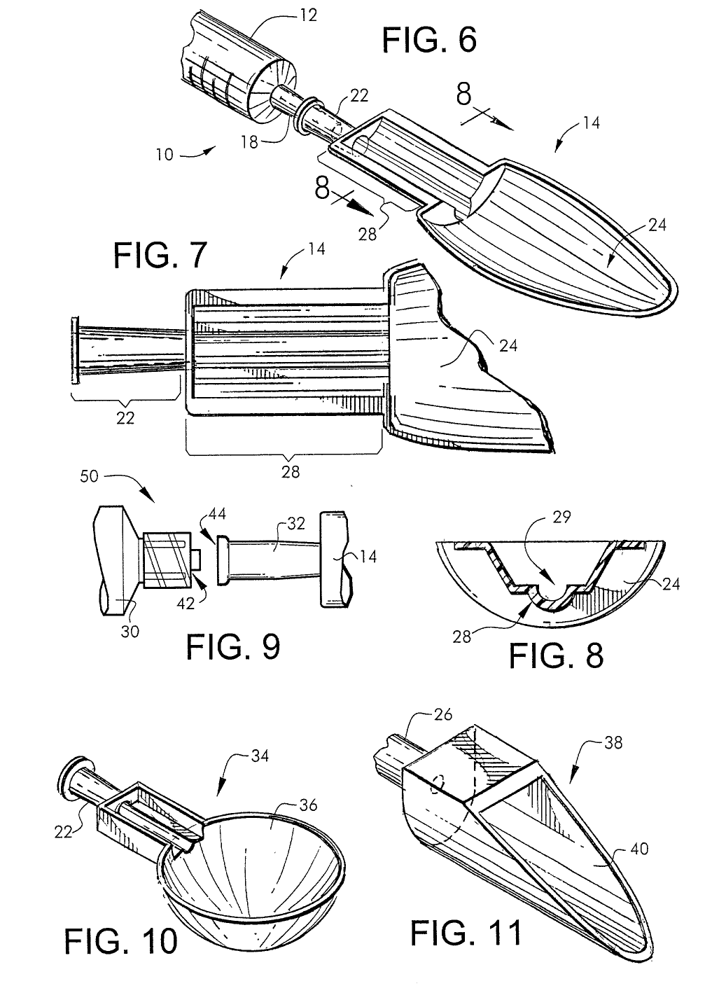

Referring to FIG. 6, a perspective view of the system 10, according to another preferred embodiment of the present invention, is shown. The syringe 12 preferably comprises at least one male slip coupling 18, and the dispensing spoon 14 preferably comprises at least one female slip coupling 22, into which the male slip coupling 18 slides to form a friction fit. This alternate embodiment of the dispensing spoon 14 further comprises at least one extended transfer channel 28, open on the top, and at least one bowl section 24. The liquid 20 from the syringe 12 is transferred from the syringe 12 through the extended transfer channel 28 and into the bowl section 24. A feature of this alternate embodiment is that the system 10 may be maintained in a slightly off-horizontal orientation, causing the dispensed liquid from the syringe 12 to collect within the extended transfer channel 28 (herein embodying a liquid dispensing and administering system wherein such channel means is sized to receive a measured amount of the at least one liquid from the at least one liquid source while placed in a substantially horizontal orientation). This feature provides for a more stable system of preparing the liquid for administering to the recipient, as the system 10 need not be rotated to transfer the liquid into the bowl section 24 until just prior to placing the bowl section 24 into the recipient's mouth. It should be noted that the extended transfer channel 28 may also comprise an enclosed top, which would then allow the transfer of the liquid from the syringe 12 into the extended transfer channel 28, while the system 10 is maintained in a substantially vertical orientation (herein embodying a liquid dispensing and administering system wherein such channel means is sized to receive a measured amount of the at least one liquid from the at least one liquid source while placed in a substantially vertical orientation).

Referring to FIG. 7, an enlarged partial top view of the system 10 of FIG. 6, according to a preferred embodiment of the present invention, is shown. The extended transfer channel 28 is shown in closer detail therein.

FIG. 8 shows a sectional view through section 8-8 of FIG. 6 of the liquid dispensing and administering system 10, according to a preferred embodiment of the present invention. The preferred sectional profile of the extended transfer channel 28 is shown therein.

FIG. 9 shows an elevational view of a lock coupling 50 used in preferred embodiments of the present invention. The lock coupling 50 enables a more secure engagement between a syringe 12 (see FIGS. 1, 2 and 6) and the dispensing spoon 14. The lock coupling 50 preferably comprises a standard male end 30 having a male twist lock end 42, as shown. The lock coupling 50 further preferably comprises a female end 32, further comprising a female twist lock end 44, as shown. The male twist lock end 42 may be inserted and twist-locked into the female twist lock end 44. Preferably, the female end 32 is coupled to the dispensing spoon 14, as shown. Preferably, the male end 30 is coupled to at least one syringe 12 (see FIGS. 1, 2 and 6) or, under appropriate circumstances, other liquid sources having a suitable male fitting. For example, a liquid supply tube from at least one liquid source may be coupled to the male end 30. A dispensing spoon 14 could then be coupled, via the female end 32 of the dispensing spoon 14, to the male end 30. Following a first administration of the liquid in this manner, the dispensing spoon 14 could be removed and another clean and unused dispensing spoon 14 could be coupled, as previously described. Thus, this lock coupling 50 feature, in addition to securely coupling the components, also allows a single liquid source to safely and hygienically dispense measured liquids to multiple recipients without fear of cross-contamination or spread of germs.

Referring to FIG. 10, a perspective view of the system 10, according to a further preferred embodiment of the present invention, is shown. This further preferred embodiment preferably comprises a dispensing spoon 34 preferably having a hemisphere-shaped bowl section 36. The dispensing spoon 34 also preferably comprises at least one female slip coupling 22. Those skilled in the art will recognize that this hemisphere-shaped bowl section 36 may be preferable in appropriate circumstances due to such inherent characteristics as its size-to-volume ratio, etc.

Referring to FIG. 11, a perspective view of the system 10, according to yet another preferred embodiment of the present invention, is shown. The embodiment of FIG. 11 preferably comprises a dispensing spoon 38 having a scoop-shaped bowl section 40. The dispensing spoon 38 also preferably comprises at least one female slip coupling 22. Those skilled in the art will recognize that this scoop-shaped bowl section 40 may be preferable, in appropriate circumstances, due to such characteristics as its volume, pouring characteristics and ability to retain liquids in an essentially vertical position. Although the use for dispensing is highly preferred, the system, under appropriate circumstances, may alternately be suitable as a collector for receiving a liquid prior to final containment within a holder such as a syringe. As just one example, such a system might be used to assist in the collection of spinal fluid during a lumbar puncture (spinal tap).

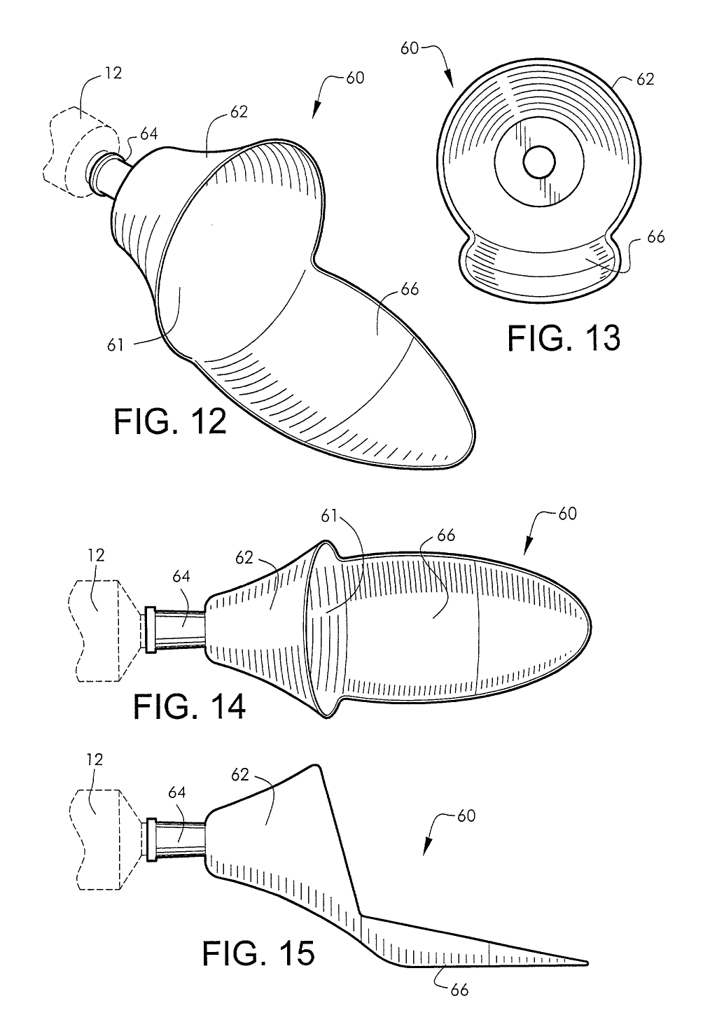

FIG. 12 is a perspective view showing a liquid dispensing and administering system 10 comprising a funnel-shaped dispensing spoon 60, according to another preferred embodiment of the present invention. The funnel-shaped dispensing spoon 60 has a preferred feature of comprising at least one adaptation to assist in filling a syringe 12, as shown. The funnel-shaped dispensing spoon 60 preferably comprises at least one coupling 64, either of slip or lock configuration, as shown. This preferred embodiment preferably comprises at least one enlarged variation of the short transfer channel 26 described in FIG.(S) 1-11. In the embodiment of FIG. 12, the short transfer channel 26 has been modified to form at least one funnel-shaped body 62 connected to the coupling 64, and at least one spoon 66 integral to the funnel-shaped body 62. This preferred embodiment couples to at least one liquid source as in the previously discussed embodiments of FIG.(S) 1-11. In use, the funnel-shaped dispensing spoon 60 is connected, preferably by at least one connection, to at least one syringe 12. Preferably, the funnel-shaped dispensing spoon 60 and syringe 12, in combination, is positioned in a substantially vertical orientation with the large opening of the funnel-shaped body 62 (herein embodying at least one hollow cone having at least one first wider open end and at least one second narrower open end) facing generally upward. A liquid to be measured and dispensed is then poured into the funnel-shaped body 62. As the plunger of the syringe 12 is pulled back, the suction pressure created within the syringe 12 draws the liquid from the funnel-shaped body 62 down into the syringe 12, thus, an easy means of filling a syringe without placing the tip of the syringe 12 into the source is provided, as shown. The funnel-shaped dispensing spoon 60 is then used, as previously discussed, to allow the user to administer liquids to a recipient. This preferred feature prevents the cross-contamination of source liquids and the spread of disease by isolating the liquid source from contact with both the syringe 12 and funnel-shaped dispensing spoon 60.

FIG. 13 is a front elevational view of a liquid dispensing and administering system 10 comprising a funnel-shaped dispensing spoon 60, according to another preferred embodiment of the present invention. Although an essentially bi-symmetrical configuration is shown, it is within the scope of the present invention to provide asymmetrical embodiment that, under appropriate circumstances, provides a more efficient orientation of parts to meet one or more specific applications.

FIG. 14 is a top plan view of a liquid dispensing and administering system 10 comprising a funnel-shaped dispensing spoon 60, according to another preferred embodiment of the present invention. Preferably the spoon 66, integral to the funnel-shaped body 62, is approximately oval-shaped, having smoothly formed edges, as shown. Under appropriate circumstances, the spoon 66 and the funnel-shaped body 62 may be formed with additional features, such as grip assisting tabs, support legs and similar secondary components, to facilitate ease of use and comfortable engagement with the recipient.

FIG. 15 is a side elevational view of a liquid dispensing and administering system 10 comprising a funnel-shaped dispensing spoon 60, according to another preferred embodiment of the present invention. Preferably, the spoon 66 defines at least one essentially concave cavity portion, smoothly integrated with the interior profile of the funnel-shaped body 62, as shown. Although it is presently preferred that the funnel-shaped body 62, spoon 66 and coupling 64 be formed from a single material, under appropriate circumstances, two or more separate materials may be used; for example, to produce an infant-safe spoon 66 using a more pliable plastic portion.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1) A liquid dispensing and administering system for the controlled dispensing of at least one liquid from at least one liquid source to a mouth of at least one user comprising, in combination:
a) dispenser-spoon means for delivering at least one liquid into the mouth;
b) coupling means for coupling said dispenser-spoon means to the at least one liquid source; and
c) channel means for transfer of the at least one liquid from said coupling means to said dispenser-spoon means.

2) The liquid dispensing and administering system according to claim 1 wherein said channel means is sized to receive a measured amount of the at least one liquid from the at least one liquid source while placed in a substantially vertical orientation.

3) The liquid dispensing and administering system according to claim 1 wherein said dispenser-spoon means is sized to receive a measured amount of the at least one liquid from the at least one liquid source while placed in a substantially horizontal orientation.

4) The liquid dispensing and administering system according to claim 1 wherein said channel means is sized to receive a measured amount of the at least one liquid from the at least one liquid source while placed in a substantially horizontal orientation.

5) The liquid dispensing and administering system according to claim 1 wherein said channel means is structured and arranged to retain such minimal amount of a measured amount of the at least one liquid being transferred that substantially all of the measured amount may be dispensed.

6) A liquid dispensing and administering system for the controlled dispensing of at least one liquid from at least one liquid source to a mouth of at least one user comprising, in combination:
a) at least one dispenser-spoon structured and arranged to hold the at least one liquid to be dispensed;
b) at least one coupling structured and arranged to removably couple said at least one dispenser-spoon to the at least one liquid source; and
c) at least one channel structured and arranged to transfer the at least one liquid from said at least one coupling to said at least one dispenser-spoon.

7) The liquid dispensing and administering system according to claim 6 wherein said at least one coupling comprises at least one luer slip coupling.

8) The liquid dispensing and administering system according to claim 6 wherein said at least one coupling comprises at least one luer lock coupling.

9) The liquid dispensing and administering system according to claim 6 wherein said at least one coupling is structured and arranged to receive at least one oral syringe safety tip.

10) The liquid dispensing and administering system according to claim 6 wherein said channel is structured and arranged to retain such minimal amount of a measured amount of the at least one liquid being transferred that substantially all of the measured amount may be dispensed.

11) The liquid dispensing and administering system according to claim 6 wherein said at least one dispenser-spoon is sized to receive at least one measured amount of the at least one liquid while placed in a substantially horizontal orientation.

12) The liquid dispensing and administering system according to claim 6 wherein said at least one channel is sized to contain at least one measured amount of the at least one liquid while placed in a substantially horizontal orientation.

13) The liquid dispensing and administering system according to claim 6 wherein said at least one channel is sized to contain at least one measured amount of the at least one liquid while placed in a substantially vertical orientation.

14) The liquid dispensing and administering system according to claim 13 wherein said at least one channel comprises:
a) at least one hollow cone having at least one first wider open end and at least one second narrower open end;
b) wherein at least one portion of said at least one first wider open end is integral with said at least one dispenser-spoon; and
c) wherein said at least one narrower second open end is integral with said at least one coupling.

15) A liquid dispensing and administering system for the controlled dispensing of at least one liquid from at least one liquid source to a mouth of at least one user comprising, in combination:
a) at least one syringe;
b) at least one dispenser-spoon structured and arranged to hold the at least one liquid to be dispensed;
c) at least one intermediate coupling structured and arranged to removably couple said at least one dispenser-spoon to said at least one syringe; and
d) at least one channel structured and arranged to transfer the at least one liquid from said at least one intermediate coupling to said at least one dispenser-spoon; and
e) wherein said at least one syringe comprises at least one luer coupling.

16) The liquid dispensing and administering system according to claim 15 wherein said at least one luer coupling comprises at least one luer slip coupling.

17) The liquid dispensing and administering system according to claim 16 wherein said channel is structured and arranged to retain such minimal amount of a measured amount of the at least one liquid being transferred that substantially all of the measured amount may be dispensed.

18) The liquid dispensing and administering system according to claim 16 wherein said at least one channel is sized to receive at least one measured amount of the at least one liquid while placed in a substantially horizontal orientation.

19) The liquid dispensing and administering system according to claim 16 wherein said at least one channel is sized to receive at least one measured amount of the at least one liquid while placed in a substantially vertical orientation.

20) The liquid dispensing and administering system according to claim 19 wherein said at least one channel comprises:
a) at least one hollow cone having at least one first wider open end and at least one narrower second open end;
b) wherein at least one portion of said at least one first wider open end is integral with said at least one dispenser-spoon; and
c) wherein said at least one second narrower open end is integral with said at least one luer slip coupling.

21) The liquid dispensing and administering system according to claim 15 wherein said at least one luer coupling comprises at least one luer lock coupling.

22) The liquid dispensing and administering system according to claim 21 wherein said channel is structured and arranged to retain such minimal amount of a measured amount of the at least one liquid being transferred that substantially all of the measured amount may be dispensed.

23) The liquid dispensing and administering system according to claim 21 wherein said at least one channel is sized to receive at least one measured amount of the at least one liquid while placed in a substantially horizontal orientation.

24) The liquid dispensing and administering system according to claim 21 wherein said at least one channel is sized to receive at least one measured amount of the at least one liquid while placed in a substantially vertical orientation.

25) The liquid dispensing and administering system according to claim 24 wherein said at least one channel comprises:
a) at least one hollow cone having at least one first wider open end and at least one narrower second open end;
b) wherein at least one portion of said at least one first wider open end is integral with said at least one dispenser-spoon; and
c) wherein said at least one narrower second open end is integral with said at least one luer lock coupling.
